(19) United States
(12) Patent Application Publication
(10) Pub. No.: US 2005/0052735 A1
(43) Pub. Date: Mar. 10, 2005

(54) Optical modulation element for using in microscopes

(76) Inventor: Carsten Hoyer, Juehnde (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/490,399

(22) PCT Filed: Sep. 18, 2002
(86) PCT No.: PCT/EP02/10443

(30) Foreign Application Priority Data
Sep. 28, 2001 (DE) 101 48 782.7

(51) Int. Cl. G02B 21/06

(52) U.S. Cl. 359/388; 359/368

(57) ABSTRACT

The invention is directed to an optical modulator for use in an optical microscope, which modulator enables the adjustment of different contrast methods. For this purpose, the modulator comprises two plates of different transparency which can be introduced into the illumination beam path of the microscope in a deliberate manner.

### CROSS-REFERENCE TO RELATED APPLICATIONS

This application claims priority of International Application No. PCT/EP02/10443, filed Sep. 18, 2002 and German Application No. 101 48 782.7, filed Sep. 28, 2001, the complete disclosures of which are hereby incorporated by reference.

### BACKGROUND OF THE INVENTION

a) Field of the Invention

The invention is directed to an optical modulation element for use in an optical microscope.

b) Description of the Related Art

It is known in microscopy that objects which do not exhibit any differences in transparency relative to the surroundings but differ only in the index of refraction or in the thickness of the surrounding medium cannot be made visible by standard brightfield microscopy methods.

In order to make these objects visible, phase contrast arrangements such as those described, e.g., in the German Patents DR 63 61 68 and DE 97 41 73 are used. In these arrangements, phase rings, as they are called, are usually arranged in the exit pupil of the objective and are imaged on corresponding diaphragms arranged in conjugate planes of the illumination beam path. These phase rings are composed of ring-shaped structures which change the phase or amplitude of the transmitted light. As a rule, corresponding circular diaphragms are arranged in the back focal plane of the condenser in such a way that they are imaged exactly on the phase rings by the optical system comprising condenser and objective.

It was suggested in DE-OS 25 23 463 and 25 23 454 to use three stripe-shaped areas with different optical characteristics (transparency, color, polarization, phase displacement) instead of the ring-shaped structures. In so doing, a relief effect similar to that occurring in one-sided oblique illumination is added to the visualization of the phase differences. This effect is called, after its inventor, Hoffman modulation contrast. The ring-shaped or stripe-shaped structures mentioned above are termed modulation elements or modulators. It was also proposed in DE-OS 25 23 463 that the size and shape of the modulator are adjustable and the transparency of the middle region can be varied. The technical apparatus by means of which these variations can be realized were not disclosed. Also, in the ensuing time, the corresponding microscopes were built exclusively with predetermined modulators which could not be altered by the user. Accordingly, it was only possible to adapt the observation conditions to the particular characteristics of the specimen to be examined microscopically by exchanging the modulators, as was stated, e.g., in U.S. Pat. No. 5,969,853 using a multitude of different modulators.

### OBJECT AND SUMMARY OF THE INVENTION

It is the primary object of the invention to overcome these disadvantages of the prior art and to provide an optical modulator which can be adapted to different specimen conditions in a simple manner.

According to the invention, this object is met through an optical modulation element for use in an optical microscope with an optical beam path comprising at least three areas of different optical characteristics, wherein means are provided which vary the effective size of the optical areas and/or the optical characteristics of the areas in the beam path.

Additional advantageous developments of the invention are set forth in the dependent claims.

It is advantageous when two or more optical elements of different transparency are introduced into the optical beam path together or individually in a defined manner, i.e., with a predetermined effective cross section. Preferred optical elements are plates, a first plate preferably being made of glass and having a transparency of 50% and a second plate having a transparency of 0%, these plates being oriented substantially perpendicular to the optical axis of the microscope. In order to realize a transparency of 100%, the light is allowed to pass unimpeded at predetermined points. In another advantageous construction of the invention, the optical elements are glass plates which are provided with a striped pattern with a sin² distribution of transparency resulting in an average transparency of 50%, and the periods of the sin² distribution are preferably equal.

In a preferred construction of the invention, the two plates are realized in the form of slides as is conventional in microscopy to a great extent, e.g., in the form of filter slides. By introducing the slides and, therefore, the plates to varying extents, different areas with different transparency values can be realized in the optical beam path of the microscope in a simple manner. A particularly preferred realization of the invention results when the two slides have, at their sides facing one another, projections which can engage one inside the other so that when one slide moves the second slide is carried along. In this way, the second slide can be realized without its own actuating element but can be introduced into the beam path or removed from the beam path in a defined manner nevertheless.

Surprisingly, events can be achieved by the modulator, according to the invention, which correspond not only to Hoffman modulation contrast but which are also comparable to VAREL contrast (variable relief contrast, described in DE-GM 82 19 123); further, one-sided darkfield and brightfield can both be realized.

The positions of the two glass plates relative to one another which are necessary to realize the different types of contrast will be described in the following with reference to a preferred embodiment example.

### BRIEF DESCRIPTION OF THE DRAWINGS

In the drawings:

FIG. 1 is a schematic side view of the modulator according to the invention; and

FIGS. 2 to 4 show different settings of the modulator for realizing the different types of contrast.

### DESCRIPTION OF THE PREFERRED EMBODIMENTS

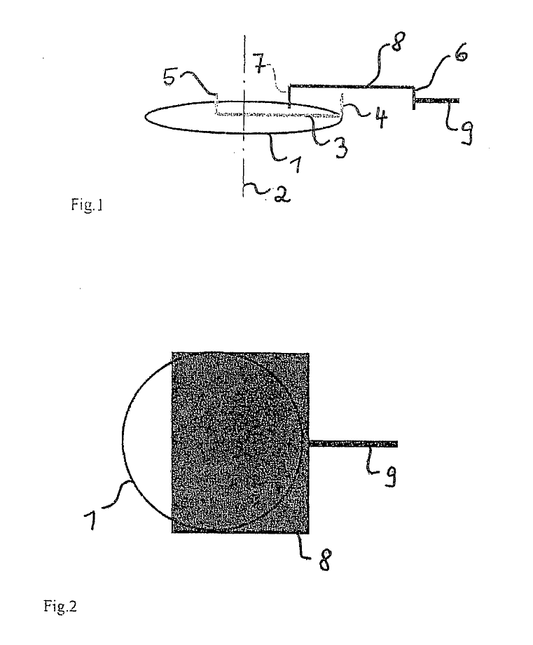

In FIG. 1, the modulator receptacle 1 of a condenser, not shown, defines the effective beam cross section of the illumination beam path of a microscope, also not shown. A glass plate 3 which is movable in the modulator receptacle 1 perpendicular to the optical axis 2 of the illumination beam path has a transparency of 50% and, by means of a front projection 4 and a rear projection 5, can be brought into a working connection with a front projection 6 and a rear projection 7 of a second plate 8 having a transparency of 0%. This second plate 8 is likewise movable perpendicular to the optical axis 2 by means of an actuating element 9.

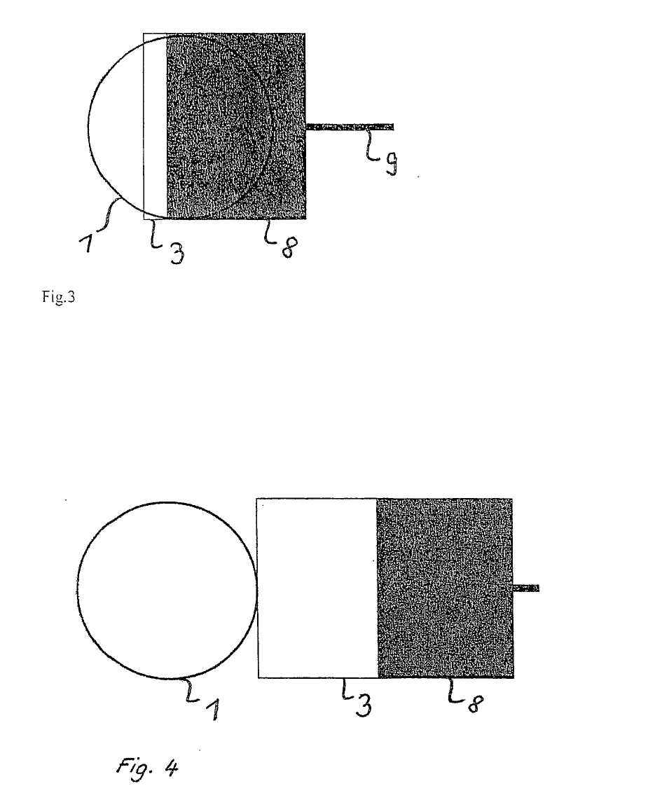

When the plate 8 is introduced into the beam path by means of the actuating element 9 proceeding from the position shown in FIG. 1, the nontransparent plate 8 slides over the half-transparent plate 3. The plate 3 is then carried along by means of the rear projections 5 and 7 until reaching an end stop, not shown. This results in darkfield illumination on one side, as is shown in FIG. 2.

When the plate 8 is pulled out of the beam path by means of the actuating element 9, the half-transparent plate 3 initially remains in place and the plate 3 opens up an area of the beam path with a transparency of 50%. The result is shown in FIG. 3 and causes the normal Hoffman modulation contrast.

When the plate 8 is pulled farther out of the beam path, there is an increase in the proportion of the effective cross section of the illumination beam path which is damped by 50%; this results in a modified Hoffman modulation contrast. When the plate 8 is pulled out farther, the rear projection 7 of the plate 8 enters into a working connection with the front projection 4 of the half-transparent plate 3 and carries it along in the continuing process, so that the beam path is cleared. In the front end position shown in FIG. 4, the illumination beam path is not influenced by the modulator and normal brightfield illumination results.

On the whole, any desired distributions of the unaffected illumination that is damped by 50% and completely blocked can be realized with this embodiment of the invention, which allows variable adaptation of the imaging ratios to the specimen in a simple manner.

In another advantageous realization of the invention, the two plates 3 and 8 are made of glass and each has a stripe structure with a sin² distribution of transparency and equal periods. The transparency changes spatially between 0 and 100% and the mean transparency is accordingly 50%. The arrangement and movement of the plates 3 and 8 is realized in the same way as in the embodiment example described above. With this solution, it is possible, in addition, to vary the transparency in the overlapping area of the two plates in a sensitive manner between 50% (stripe structures are coincident) and 100% (stripe structures are shifted by a half period relative to one another).

The realization of the invention is not limited to the indicated embodiment examples; in particular, other arrangements can also be realized for displacing the optical apparatus of the modulator.

Further, it is possible within the framework of the invention to design the two plates 3 and 8 in such a way that optical characteristics other than transparency, e.g., color, polarization, or phase displacement, can be varied in a deliberate manner.

While the foregoing description and drawings represent the present invention, it will be obvious to those skilled in the art that various changes may be made therein without departing from the true spirit and scope of the present invention.

1-9. (cancelled).

10. An optical modulation element for use in an optical microscope with an optical beam path having at least three areas of different optical characteristics, comprising:
means which vary the effective size of the optical areas and/or the optical characteristics of the areas in the beam path.

11. The optical modulation element according to claim 10, wherein the means for varying the optically active areas comprise at least a first and a second optical element of different transparency which can be introduced individually and/or together into the optical beam path in such a way that their effective surface in the optical beam path is variable.

12. The optical modulation element according to claim 11, wherein the first optical element is a glass plate preferably having a transparency of 50% and the second optical element is a plate preferably having a transparency of 0%, these plates being oriented substantially perpendicular to the optical axis of the optical beam path.

13. The optical modulation element according to claim 11, wherein the first optical element and the second optical element are glass plates which are oriented substantially perpendicular to the optical axis of the optical beam path and have a striped pattern with a sin² distribution of transparency, wherein the average transparency is preferably 50%.

14. The optical modulation element according to claim 13, wherein the periods of the sin² distribution of transparency of the first optical element and of the second optical element are substantially equal.

15. The optical modulation element according to claim 11, wherein the two optical elements are constructed as slides.

16. The optical modulation element according to claim 15, wherein the two slides are coupled together and only one of the two slides has an actuating element.

17. The optical modulation element according to claim 16, wherein the first slide has an actuating element and, substantially at its distal side and at its proximal side, a projection which is directed toward the second slide, wherein the second slide likewise has projections substantially at its distal side and at its proximal side which are directed toward the first slide, and wherein the projections can be brought into a detachable engagement with one another by means of the actuating element, so that a defined driving movement of the second slide can be caused when actuating the operator control.

18. A microscope comprising an optical modulation element according to claim 10.
